(19) United States
(12) Patent Application Publication
(10) Pub. No.: US 2026/0267179 A1
(43) Pub. Date: Sep. 10, 2026

(54) SWITCHABLE LIGHT FILTER, AND LIGHTING APPARATUS AND SCREEN WITH SUCH SWITCHABLE LIGHT FILTER

(71) Applicant: SIOPTICA GMBH, Jena (DE)

(72) Inventor: André Heber, Jena (DE)

(73) Assignee: SIOPTICA GMBH, Jena (DE)

(21) Appl. No.: 19/557,091

(22) Filed: Mar. 4, 2026

(30) Foreign Application Priority Data
Mar. 5, 2025 (DE) 10 2025 108 300.2

(51) Int. Cl. G02F 1/13; G02F 1/1335

(52) U.S. Cl. CPC G02F 1/1323; G02F 1/133528

(57) ABSTRACT

The present application relates to a switchable light filter comprising a first optical element 1 configured to transmit or at least partially absorb light according to a polarization state and/or an incidence direction thereof, means for selectively generating a first electric field or a second electric field, a first linear polarizer, a liquid crystal layer to which the first electric field or the second electric field is applied and which influences a polarization state of light passing therethrough depending thereon, so that transmission properties of the switchable light filter differ between a first operation mode in which the first electric field is applied and a second operation mode in which the second electric field is applied, wherein the first electric field or the second electric field is generated by applying a voltage U to said means for selectively generating a first electric field or a second electric field.

### CROSS-REFERENCE TO RELATED APPLICATION

This application claims priority to German Patent Application No. 10 2025 108 300.2, filed on Mar. 5, 2025, which is hereby incorporated by reference in its entirety.

### TECHNICAL FIELD

In recent years, significant advances have been made in widening the viewing angle of LCDs. However, there are situations in which the relatively large viewing range of a screen can be disadvantageous. Information on mobile devices, such as notebooks and tablet PCs, becomes increasingly available, such as bank data or other personal details, and sensitive data. Accordingly, people need control over who is allowed to see this sensitive data; they must be able to choose a wide viewing angle (i.e., a public mode) to share information on their display with others, e.g., when viewing vacation photos or also for advertising purposes. On the other hand, they need a small viewing angle (i.e., a private mode) when they want to handle the image information confidentially.

A similar problem arises in automotive engineering. The driver must not be distracted by image contents, such as digital entertainment programs, when the engine is switched on, while the passenger, however, would like to consume these even during the journey. Thus, a screen that can switch between the corresponding display modes is needed.

Additional films based on micro-louvers have already been used for mobile displays to achieve their visual privacy protection. However, these films were not switchable or convertible, and they always had to be placed by hand first and then removed again. Also, one must transport them separately to the display when one does not need them just now. A significant disadvantage of the use of such louver films is further connected with the accompanying light losses.

### BACKGROUND

U.S. Pat. No. 6,765,550 B2 describes such an anti-peeping protection using micro-louvers. The greatest disadvantages here are the mechanical removal/attachment of the filter and the light loss in the privacy mode.

WO 2015/121398 A1 of the applicant describes a screen with two operation modes, in which scattering particles in the volume of the corresponding light guide are used for switching between the operation modes. However, the scattering particles selected there, made of a polymer, generally have the disadvantage that light is coupled out from both large surfaces, whereby approximately half of the useful light is emitted in the wrong direction, namely toward the backlight, and due to the structure, cannot be recycled there to a sufficient extent. Moreover, the scattering particles made of polymer distributed in the volume of the light guide may, under certain circumstances, especially at higher concentrations, lead to scattering effects that reduce the anti-peeping effect in the protected operation mode.

The aforementioned methods and arrangements generally share the disadvantage that they significantly reduce the brightness of the base display screen and/or require a complex and expensive optical element for mode switching and/or reduce the resolution in the freely viewable public mode and/or exhibit visual artifacts in very high-resolution displays. Moreover, it is generally not possible to specifically generate asymmetric transmission distributions for selected directions.

Furthermore, DE 10 2023 110 269 B3 of the applicant describes a switchable light filter, a lighting apparatus, and a screen. In this case, absorbing transition dipole moments are used for switching between two modes, which transmit light directionally depending on the polarization state or at least partially absorb it. By changing the polarization of the light incident on the light filter, a switching between different modes is accordingly achieved.

### SUMMARY

The object of the present application is to provide a switchable light filter which influences the transmission of light in an angle-dependent manner, wherein switching between at least two operation modes is possible. In particular, asymmetric transmission distributions are to be generated for selected directions. Furthermore, a corresponding lighting apparatus and screen are disclosed.

According to the present application, this object is achieved by a switchable light filter comprising:
a first optical element configured to transmit or at least partially absorb light according to a polarization state and/or an incidence direction thereof, wherein a first preferred direction is selectable for the first optical element and is set at an angle α relative to a central normal of the first optical element, and the angle α is measured in a selectable first plane including said central normal;
means for selectively generating a first electric field EF1 or a second electric field EF2, e.g. ITO layers, which may also be structured;
a first linear polarizer having a transmission maximum for light linearly polarized parallel to a selectable first preferred direction;
optionally, at least one retardation layer;
a liquid crystal layer disposed between the first linear polarizer and the first optical element, to which the first electric field EF1 or the second electric field EF2 is applied to influence a polarization state of light passing therethrough,
so that a transmission property of the switchable light filter varies between a first operation mode B1 in which the first electric field EF1 is applied and a second operation mode B2 in which the second electric field EF2 is applied,
wherein the first electric field EF1 or the second electric field EF2 is generated by applying a voltage U to the means for selectively generating a first electric field EF1 or a second electric field EF2, where x₁U₀≤U≤x₂U₀ with

$${U}_{0} = π \sqrt{\frac{κ}{\vert {ε}_{p} - {ε}_{s} \vert}} ,$$

wherein κ=k₁₁ (parallel to a surface) or κ=k₃₃ (perpendicular to a surface), εₚ and εₛ correspond to the dielectric constants parallel and perpendicular to a long molecular axis, and x₁=1 and x₂=10, so that for the first operation mode B1 or the second operation mode B2, the magnitudes of the transmittance values T(α−45°) and T(α+45°) (measured along the selectable first plane) differ by at least a factor of 1.5, preferably by a factor of at least two.

Within the described voltage range, the liquid crystal molecules are only partially oriented by the electric field, i.e., the electric field lines are inclined relative to the average orientation direction of the molecules. As a result, the polarization of light is influenced according to the incidence direction thereof. When light propagates substantially parallel to the preferred direction of the molecules, the change in polarization is smaller than when the two directions differ. This change in polarization, in combination with the first optical element, leads to a variation in the light transmission.

The indices p and s denote “parallel” and “perpendicular,” respectively, referring to the dielectric constants (or dielectric function) parallel and perpendicular to the long molecular axis. Moreover, the dielectric function at the modulation frequency typically lies in the range of 10 Hz to 10 kHz.

The operation principle of the present application utilizes, inter alia, the modulation amplitude of the driver signal, i.e., the modulation amplitude of the electric fields EF1, EF2, . . . applied to the liquid crystal layer. For example, the first operation mode B1 may be one in which relatively high transmittance values are generated over large angular ranges along the first plane; thus, the first operation mode B1 is a free view mode, particularly when a switchable light filter is combined with an image display apparatus. According to embodiments of the present application, an asymmetry in the transmittance values can be achieved in the first operation mode B1.

Advantageously, one of the achievable operation modes, e.g., the first operation mode B1, has a maximum tilt angle of the director satisfying 80°≥θₘₐₓ≥20°, which can be ensured by appropriate selection of the first electric field EF1, as will be explained further below.

In a first embodiment of the switchable light filter, the first optical element comprises a linear polarizer. This polarizer transmits light polarized parallel to the selectable first direction with maximum transmission, which, in combination with the liquid crystal layer, corresponds to a “dual-cell” configuration known in the prior art. In this case, the first preferred direction and the selectable first direction are typically parallel or perpendicular to each other. In this first embodiment, the liquid crystal layer provides, in one state, an angle-dependent polarization of the light passing through it. The linear polarizer, serving as the first optical element, exhibits increased absorption at larger incidence angles, whereas in another state, the liquid crystal layer alters the polarization properties of the light only slightly, if at all, so that the linear polarizer transmits light from all incidence angles. Here, the first preferred direction is selected, by way of example, to be parallel to the normal of the first optical element.

In contrast, in a second embodiment of the switchable light filter, the first optical element comprises light-absorbing transition dipole moments, wherein permanently or at least in a first state, a plurality of the transition dipole moments are aligned, with a tolerance of at most +/−20°, parallel to the selectable first preferred direction or fluctuate around the selectable first preferred direction, so that light incident on the first optical element is transmitted or at least partially absorbed according to an incidence direction relative to the first optical element and a polarization state thereof. Generally, with such an optical element, s-polarized light is transmitted in almost all directions except for losses, whereas p-polarized light having incidence angles that deviate from the first preferred direction by more than about 20° is more strongly absorbed, wherein the absorption increases with the magnitude of the deviation.

The plurality of light-absorbing transition dipole moments in such first optical element are typically arranged in a layer having a thickness of at least 0.2 μm. Multiple layers of transition dipole moments may also be provided, which are separated, for example, by OCA (Optically Clear Adhesive) and/or substrates. The layer thickness of the transition dipole moments may range, for instance, from 0.2 μm to 50 μm, preferably from 0.2 μm to 20 μm, and particularly preferably from 1 μm to 10 μm. In a preferred embodiment, the first optical element comprises two, three, or more layers of transition dipole moments, each having a thickness of 1 μm to 10 μm. Each of these layers is provided on a substrate (e.g., made of TAC or another material having low or no birefringence, with a thickness preferably less than 100 μm), and the substrates, together with their respective layers of transition dipole moments, are bonded to one another using an OCA (Optically Clear Adhesive). The layers of transition dipole moments may each have the same thickness, within a selectable tolerance, e.g., 10% or 20%. Alternatively, they may have different thicknesses.

In principle, the first linear polarizer may be disposed at various positions within the switchable light filter. The general sequence of the first optical element, the liquid crystal layer, and the first linear polarizer may be reversed in the viewing direction. The optical effect remains unchanged.

Furthermore, at least one retardation layer may be disposed between the first optical element and the first linear polarizer.

In some particular embodiments, the switchable light filter may comprise at least two first optical elements, wherein a retardation layer is optionally disposed between at least two such first optical elements. Further details regarding the advantages of this variant are described, inter alia, in WO 2024/133018 A1 of the applicant. Furthermore, optionally, at least two first optical elements may have different thicknesses of the layers each including the plurality of light-absorbing transition dipole moments, but need not.

Generally, for the switchable light filter, the potentials between the electrodes for applying the first electric field EF1 and the second electric field EF2 differ by at least 2 volts.

Furthermore, the first optical element and/or the liquid crystal layer and/or the means for selectively generating a first electric field EF1 or a second electric field EF2 may be subdivided into a plurality of separately switchable segments, thereby enabling local switching between the respective operation modes. Depending on the application, the separately switchable segments may be provided in numbers ranging from a single digit up to a very large count (several million segments) for fine pixelation.

The present application further provides a lighting apparatus for a screen adapted to operate in at least two operation modes including a first operation mode B1 for a free view mode and a second operation mode B2 for a limited view mode, in which light is emitted within a viewing angle range that is limited for an observer compared to the free view mode, the lighting apparatus comprising:
a backlight extended in a flat manner and configured to emit light; and
a switchable light filter as described above, disposed in front of the backlight in a viewing direction.

The present application further provides a screen adapted to operate in at least two operation modes including a first operation mode B1 for a free view mode and a second operation mode B2 for a limited view mode, in which light is emitted within a viewing angle range that is limited for an observer compared to the free view mode, the screen comprising:
a lighting apparatus as described above, wherein the switchable light filter of the lighting apparatus comprises the first optical element, the means for selectively generating the first electric field EF1 or the second electric field EF2, the liquid crystal layer disposed behind or in front of the first optical element in a viewing direction, and the first linear polarizer disposed in front of the liquid crystal layer in the viewing direction, under a condition that the liquid crystal layer is disposed in front of the first optical element in the viewing direction;
a second linear polarizer, which is disposed in front of the backlight in the viewing direction, under a condition that no first linear polarizer is disposed in the switchable light filter of the lighting apparatus, wherein light emitted from the backlight and passing through the second linear polarizer is limited in a propagation direction thereof; and
a transmissive display apparatus disposed in front of the switchable light filter in the viewing direction,
wherein in the second operation mode B2, the second electric field EF2 is applied, and in the first operation mode B1, the first electric field EF1 is applied.

Preferably, the selection of the voltage U is performed for the first operation mode B1, whereas for the second operation mode B2, preferably a field-free second electric field EF2 (i.e., U=0) is applied.

Under a condition that the first linear polarizer is provided, the first linear polarizer is disposed in or on the transmissive display apparatus or forms a part thereof; under a condition that the first linear polarizer is not provided, the second linear polarizer is disposed in or on the transmissive display apparatus or forms a part thereof.

The present application further provides a screen adapted to operate in at least two operation modes including a first operation mode B1 for a free view mode and a second operation mode B2 for a limited view mode, in which light is emitted within a viewing angle range that is limited for an observer compared to the free view mode, the screen comprising:
a display apparatus;
a switchable light filter as described above, which is disposed in front of the display apparatus in a viewing direction, wherein the switchable light filter comprises:
the first optical element;
the means for selectively generating a first electric field EF1 or a second electric field EF2;
the liquid crystal layer disposed behind or in front of the first optical element in the viewing direction; and
the first linear polarizer disposed in front of the liquid crystal layer in the viewing direction, under a condition that the liquid crystal layer is disposed in front of the first optical element in the viewing direction,
wherein in the second operation mode B2, the second electric field EF2 is applied, and in the first operation mode B1, the first electric field EF1 is applied.

The switchable light filter may be configured to be subsequently attached by a user and/or reversibly mounted to the display apparatus.

Furthermore, a second optical element may be disposed in front of the transmissive display apparatus in the viewing direction, the second optical element comprising:
light-absorbing transition dipole moments,
wherein at least in a first state, a plurality of the transition dipole moments are aligned, with a tolerance of at most 20°, parallel to a second preferred direction selectable for the second optical element or fluctuate around the second preferred direction, the second preferred direction being set at an angle α₁ relative to a central normal of the second optical element, and the angle α₁ being measured in a selectable second plane including the central normal,
so that light incident on the second optical element is transmitted or at least partially absorbed according to an incidence direction relative to the second optical element and a polarization state thereof.

The present application further provides a lighting apparatus for a screen adapted to operate in at least two operation modes including a first operation mode B1 for a free view mode and a second operation mode B2 for a limited view mode, in which light is emitted within a viewing angle range that is limited compared to the free view mode, the lighting apparatus comprising:
a backlight extended in a flat manner and configured to emit light within a limited viewing angle range, optionally configured to be self-luminous, e.g., as a FALD (Full Array Local Dimming) backlight;
a plate-shaped light guide disposed in front of the backlight in a viewing direction, wherein the plate-shaped light guide comprises light-exiting elements on at least one of large surfaces and/or within a volume thereof;
lighting components disposed laterally on at least one narrow side of the light guide; and
a switchable light filter as described above, which is disposed in front of the backlight in the viewing direction, wherein the switchable light filter comprises:
the first optical element;
the means for selectively generating a first electric field EF1 or a second electric field EF2;
the liquid crystal layer disposed behind or in front of the first optical element in the viewing direction; and
the first linear polarizer disposed in front of the liquid crystal layer in the viewing direction, under a condition that the liquid crystal layer is disposed in front of the first optical element in the viewing direction,
wherein in the second operation mode B2, the backlight is turned on and the lighting components are turned off, and in the first operation mode B1, at least the lighting components are turned on; and
in the second operation mode B2, the second electric field EF2 is applied, and in the first operation mode B1, the first electric field EF1 is applied.

The present application further provides a lighting apparatus for a screen adapted to operate in at least two operation modes including a first operation mode B1 for a free view mode and a second operation mode B2 for a limited view mode, in which light is emitted within a viewing angle range that is limited compared to the free view mode, the lighting apparatus comprising:
a backlight extended in a flat manner and configured to emit light within an unrestricted viewing angle range, and optionally configured to be self-luminous;
a plate-shaped light guide disposed in front of the backlight in a viewing direction, wherein the plate-shaped light guide comprises light-exiting elements on at least one of large surfaces and/or within a volume thereof, and the light-exiting elements are configured to primarily decouple light coupled laterally into at least one narrow side of the light guide (9c) within a limited viewing angle range;
lighting components disposed laterally on at least one narrow side of the light guide; and
a switchable light filter as described above, disposed in front of the backlight in the viewing direction, wherein the switchable light filter comprises:
the first optical element;
the means for selectively generating a first electric field EF1 or a second electric field EF2;
the liquid crystal layer disposed behind or in front of the first optical element in the viewing direction; and
the first linear polarizer disposed in front of the liquid crystal layer in the viewing direction, under a condition that the liquid crystal layer is disposed in front of the first optical element in the viewing direction,
wherein in the second operation mode B2, the backlight is turned off and the lighting components are turned on, and in the first operation mode B1, at least the backlight is turned on; and
in the second operation mode B2, the second electric field EF2 is applied, and in the first operation mode B1, the first electric field EF1 is applied.

In the present application, the term “limitation of the angular spectrum” or “limited viewing angle range” means that the corresponding luminance or light transmission is concentrated to at least 80% or 90% within a defined angular range, whereas residual light or residual transmission may still exist outside the defined limited viewing angle range, which is typically due to technical constraints. Ideally, such residual light or residual transmission is minimal and decreases with increasing angle.

The following additional features may optionally apply to the switchable light filter described above as well as to the screen or lighting apparatuses.

The liquid crystal layer may act in a scattering manner in at least one operation mode, preferably in operation mode B1.

Advantageously, the transition dipole moments of the first optical element are configured as at least one, at least two, at least three or more dichroic dye(s) mixed in a Guest-Host arrangement with the liquid crystals. For permanent transition dipole moments, the liquid crystals can preferably be fixed by a curing process.

Alternatively, the transition dipole moments can also be embedded, unfixed, in a liquid crystal layer as a Guest-Host arrangement, such that the orientation and/or magnitude of the transition dipole moments can be varied between the first state and at least one second state depending on the influence exerted on the liquid crystal layer.

In the case where the transition dipole moments are variable, e.g. by means of so-called guest-host liquid crystal cells, such guest-host liquid crystal cells can directly correspond to the aforementioned liquid crystal layer (the liquid crystal layer and the first optical element would then together form a single component), but need not.

The dichroic dye molecules are generally aligned parallel to the liquid crystal molecules.

Alternatively, the first optical element can be embodied as a laminate of layers of polymer film polarizers.

In the aforementioned embodiments, it is further ensured that the structure of the first optical element is non-periodic. This is particularly advantageous because, in combination with pixel structures of screens, there is then no risk of artifacts such as Moiré effects.

In a preferred embodiment, light passing through the liquid crystal layer is transmitted substantially unchanged upon application of the second electric field EF2, whereas upon application of the first electric field EF1, the incident light is circularly or elliptically polarized, or the polarization of the light is rotated by 90°. Here, the term “substantially” means that at the boundary surfaces, the orientation of the liquid crystal molecules is determined by electric fields and surface-induced forces, such that the liquid crystal molecules are not ideally aligned, resulting in a slight, unintended change in polarization.

For embodiments where the liquid crystal layer is configured as TN liquid crystal cells, the following applies: The orientation of the liquid crystal molecules typically differs by 90° at the large surfaces bounding the liquid crystal layer. Such orientation is achieved using PI or PVA, supplemented by mechanical or optical surface treatment. For TN liquid crystal layers, it generally further applies that upon switching between the electric fields EF1 and EF2, the majority of the liquid crystals in the liquid crystal layer are rotated out of the plane by 75 to 90 degrees. In the case of IPS and FFS liquid crystal layers, the rotations of the LC molecules are often, but not always, less than 45°, typically about 25° to 40° in the plane. However, rotations greater than 45° are expressly possible and fall within the scope of the present application.

The first electric field EF1 may, for example, have a field strength unequal to 0 V/μm, approximately in the order of 1 V/μm, e.g., as a square wave at 1 kHz, whereas the second electric field EF2, for example, has a field strength of 0 V/μm. However, the converse arrangement is also possible, as is an embodiment in which both electric fields EF1 and EF2 are non-zero. For a liquid crystal in a VA geometry with εₚ=6.6 and εₛ=3.3 and k₁₁=4·10⁻¹² N, for example, a modulation amplitude of 2.32 V/V₀ could be selected for the operation mode B1.

In particular embodiments, third, fourth, and optionally further electric fields EF3, EF4, etc., may also be generated, thereby providing additional operation modes B3, B4, etc. Herein, for example, it is particularly possible to realize three operation modes B1, B2, B3, wherein the first operation mode B1 has a maximum tilt angle of the director satisfying θₘₐₓ≥87°, the second operation mode has a maximum tilt angle of the director satisfying 80°≥θₘₐₓ≥20°, and the third operation mode B3 has a maximum tilt angle of the director satisfying θₘₐₓ≥1°. In this case, for example, the first operation mode exhibits a nearly symmetric transmission distribution, whereas in the second operation mode B2, the distribution is asymmetric, and in the third operation mode B3, the transmission is limited to an angular range.

Moreover, it is often advantageous to apply, during switching between the first and second electric fields EF1, EF2, an electric field having a field strength value between those of the first and second electric fields EF1, EF2 for a duration of a few tens to several tens of milliseconds. For example, during the switching process, approximately the average value of the field strengths of the first and second electric fields EF1, EF2 can be applied for about 50 or 80 milliseconds. Such a step-wise switching process between the first and second electric fields EF1, EF2 reduces or prevents undesired misalignments of the liquid crystals of the liquid crystal layer caused by an overly abrupt change in the field strength acting on the liquid crystal layer. Furthermore, such a step-wise switching process between the first and second electric fields EF1, EF2 can also be applied in a locally limited manner on the switchable light filter or in a screen, for example, when the electric field is to be switched only on a partial area.

Furthermore, it is also possible to vary the field strengths between the first and second electric fields EF1, EF2 gradually or in multiple steps.

When the liquid crystal layer is disposed behind the first optical element in the viewing direction, light incident on the liquid crystal layer is preferably linearly polarized light or elliptically polarized light having a ratio of a major axis to a minor axis of at least 4:1 (preferably at least 5:1 or more). This can be achieved, for example, by linear polarizers in the light path, or by λ/4 layers when the circularly polarized light is used.

For example, the first preferred direction can form an angle between 0° and 45° to a central normal of the first optical element. Furthermore, the first preferred direction may vary over the surface of the first optical element.

Furthermore, it can be advantageous that the first optical element is divided into different regions (A1, A2, . . . ) along a selectable reference line, wherein for each region (A1, A2, . . . ), a region-specific preferred direction is selectable, which applies to all transition dipole moments lying within a region (A1, A2, . . . ). All region-specific preferred directions are pairwise different and, within a tolerance of at most ±10°, point in the direction of an observer. This arrangement has the advantage that, in the limited view mode, the observer perceives a corresponding screen or a screen with a switchable light filter, as homogeneously illuminated.

The transition dipole moment (also referred to as the transition matrix element) is a quantum mechanical vector quantity associated with a specific transition between an initial state (typically the ground state) and a final state (typically an excited state) of a system, such as an atom, molecule, or solid. It corresponds to the electric dipole moment associated with this transition. The direction of the vector defines the polarization of the transition, which in turn determines how the system interacts with an electromagnetic wave of a given polarization. For example, during the transition from the ground state to an excited state, light of the corresponding polarization is absorbed. The magnitude of the vector corresponds to the strength of the interaction, i.e., the transition probability.

The first preferred direction corresponds to the orientation of the transition dipole moments of the first optical element for a given propagation direction of light at which the absorption is equal for any polarization of the light.

A first exemplary manufacturing embodiment for a first optical element with dipole moments using the guest-host principle is based on mixtures of dichroic dyes or dichroic dye mixtures with liquid crystal mixtures or compounds, and includes the following manufacturing steps (with reference to U.S. Pat. No. 9,481,658 B2 or WO 2021/177308 A1, paragraph 37 et seq.).

A substrate having low or no birefringence is coated with a film that determines the orientation of the molecules relative to the surface, typically parallel or perpendicular thereto. Polymers, preferably polyvinyl alcohol or polyimide, are used for this purpose.
Optionally, optical or mechanical treatment of the surfaces may be performed to improve the subsequent quality of the molecular alignment.
The mixture of dichroic dye and thermotropic liquid crystalline compounds or polymers is applied.
Irradiation with light causes local condensation of the side chains, such that they provide birefringence along the surface.

Alternatively, a second manufacturing embodiment uses thermotropic, liquid crystalline dichroic dyes (with reference to JP 2011-237513 A), and includes the following steps.

The corresponding dyes and addition of a polar group are prepared.
The dye mixture, as well as photo-alignment and curing of the dye mixture using polarized light, are applied.

The following materials are suitable for various manufacturing embodiments. For example, this list is not claimed to be complete.

For example, as a polymer substrate having low or no birefringence, TAC is preferably used.
As dichroic substances or mixtures, dichroic dyes (preferably azo dyes) or dichroic metal nanoparticles (preferably gold, silver, copper, and aluminum) are used; these are typically single dyes or mixtures of typically up to three different dyes to enable absorption over the entire spectrum.
For surface treatment by alignment of dyes or liquid crystalline substances, polymers, preferably polyvinyl alcohol or polyimides, are used.
For thermotropic liquid crystalline compounds or polymers, reference is made exemplarily to JP 2011-237513 A.
As chemical groups for cross-linking, which are bound to the thermotropic liquid crystalline compounds or polymers, methacryloyl groups, epoxy groups, oxetanyl groups, and styrene groups are used, preferably methacryloyl groups. Alternatively, these may be polymerizable liquid crystal compounds as described in JP 6268730 B2.
Polymerizable liquid crystalline dichroic dyes, for example, azo dyes, are also suitable.

At least one dye consists of dye molecules, wherein advantageously, a transition dipole or transition dipole moment is associated with each dye molecule, i.e., each dye molecule corresponds to a transition dipole or transition dipole moment. Typically, a dye has a mass fraction of at least 0.01%, preferably from 1% to 15%, of the material in the layers of the relevant optical element. In special cases, the concentration can even reach 95% for liquid crystalline dichroic dyes. The thickness of the layers is preferably in the range of 0.2 μm to 50 μm, preferably in the range of 0.5 μm to 20 μm, inclusive of all boundary values. The dyes or dye mixtures for different layers within an optical element can be different, but need not be.

For certain application cases where observers look at a screen as described above or a screen with a first switchable light filter, while wearing (typically vertically) linearly polarizing sunglasses, it can be advantageous that a λ/4 layer is further disposed in the light path in the viewing direction in front of the screen for converting linearly polarized light into circularly polarized light. Depending on the state of the first liquid crystal layer, left- or right-handed circularly polarized light would then be generated, which is visible through such sunglasses with reduced brightness. In the absence of such a λ/4 layer, if the linear polarization of the sunglasses and that of the light emitted from the display are crossed, an observer wearing the sunglasses might, depending on the operation state, see substantially no image.

A switchable light filter, screen, or lighting apparatus as described above is advantageously used in a mobile device, a land/air/water vehicle, in a payment terminal, or in an access system. The switching between the aforementioned operation modes can be used to protect sensitive data, i.e., to make them perceptible only to an observer, or to display image content for multiple observers simultaneously.

The functionality of the present application is essentially maintained if the described parameters are varied within certain limits.

It is understood that the features mentioned above and those described hereinafter may be used not only in the specified combinations, but also in other combinations or in isolation, without departing from the scope of the present application.

### BRIEF DESCRIPTION OF THE DRAWINGS

The present application will be described in more detail below according to exemplary embodiments with reference to the accompanying drawings, which disclose features essential for the present application. These exemplary embodiments are for illustration purposes only and are not to be interpreted as limiting. For example, a description of an exemplary embodiment with a plurality of elements or components is not to be interpreted to the effect that all of these elements or components are necessary for the implementation. In contrast, other exemplary embodiments can also include alternative elements and components, fewer elements or components, or additional elements or components. Elements or components of different exemplary embodiments can be combined with one another, unless otherwise stated. Modifications and variations, which are described for one of the exemplary embodiments, can also be applied to other exemplary embodiments. To avoid repetitions, identical or corresponding elements in different figures are identified with identical reference numerals and are not described repeatedly, in which:

FIG. 1 shows a schematic view of an exemplary arrangement of a first plane and a first preferred direction;

FIG. 2 shows a cross-sectional schematic view of an exemplary optical element;

FIG. 3 shows a schematic view of an exemplary switchable light filter in a first embodiment;

FIG. 4 shows an exemplary graph of a relationship of a maximum tilt angle of a director as a function of a normalized voltage;

FIG. 5 shows an exemplary transmittance contour diagram of an exemplary switchable light filter in a second operation mode B2;

FIG. 6 shows an exemplary transmittance contour diagram of an exemplary switchable light filter in a first operation mode B1 with a first exemplary normalized voltage;

FIG. 7 shows an exemplary transmittance contour diagram of an exemplary switchable light filter in a first operation mode B1 with a second exemplary normalized voltage;

FIG. 8 shows transmittance line profiles of an exemplary switchable light filter in a first operation mode B1 with two exemplary normalized voltages and in a second operation mode B2;

FIG. 9 shows luminance line profiles of a combination of an exemplary switchable light filter with an exemplary OLED panel;

FIG. 10 shows a schematic view of a lighting apparatus for a screen in a first embodiment;

FIG. 11 shows a schematic view of an exemplary screen in a first embodiment;

FIG. 12 shows a schematic view of an exemplary screen in a second embodiment;

FIG. 13 shows a schematic view of a lighting apparatus for a screen in a second embodiment; and

FIG. 14 shows a schematic view of a lighting apparatus for a screen in a third embodiment.

### DETAILED DESCRIPTION

The drawings are not to scale and merely illustrate the principles.

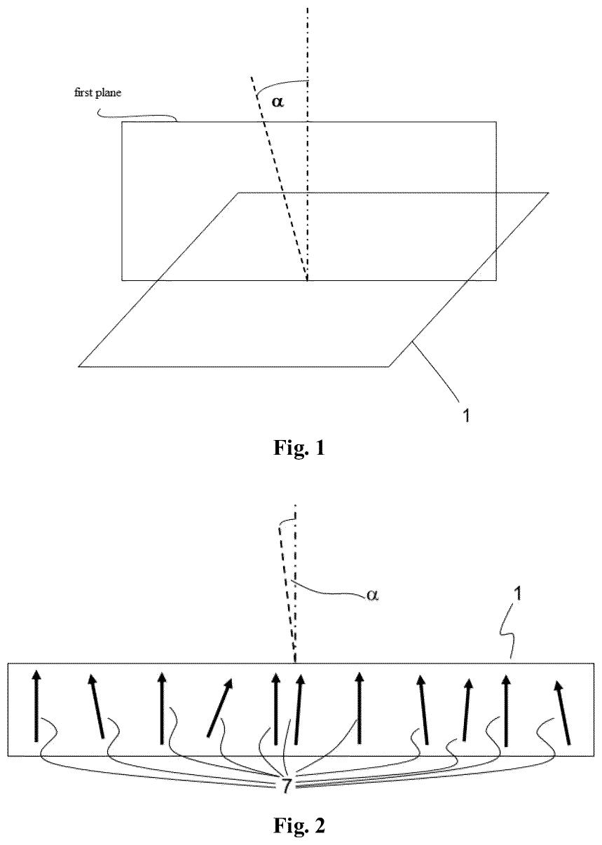

FIG. 1 shows a schematic diagram of the exemplary arrangement of a first plane and a first preferred direction (see dashed line) relative to a first optical element 1. Here, a first plane is perpendicular to the surface of the first optical element 1 and includes its central normal represented by a dash-dot line. In this first plane, the angle α is defined between the central normal and the first preferred direction (see dashed line). The central normal of the first optical element 1 and each of the connecting lines from the eyes of an observer to the center of the surface of the first optical element 1 typically enclose an angle of less than 20°, preferably less than 15°.

FIG. 2 shows a cross-sectional schematic view of an exemplary optical element. The optical element 1 comprises light-absorbing transition dipole moments 7 (see thick arrows), wherein permanently or at least in a first state, a plurality of the transition dipole moments 7 are aligned, with a tolerance of at most +/−20°, parallel to the selectable first preferred direction or fluctuate around the selectable first preferred direction, so that light incident on the first optical element 1 is transmitted or at least partially absorbed according to an incidence direction relative to the first optical element 1 and a polarization state thereof. Generally, with such an optical element 1, s-polarized light is transmitted in almost all directions except for losses, whereas p-polarized light having incidence angles that deviate from the first preferred direction by more than about 20° is partially or fully absorbed, wherein the absorption increases with the magnitude of the deviation. In FIG. 2, the dash-dot line indicates the central normal of the first optical element 1, and the dashed line indicates the first preferred direction, between which an angle α is defined. The solid arrows are intended to indicate aligned transition dipole moments 7. In the actual implementation, substantially more than just the few transition dipole moments 7 shown here are present. The transition dipole moments 7 are formed, for example, by at least two, preferably at least three, dichroic dyes, the absorption maxima of which are each at different wavelengths, e.g., at 465 nm, 532 nm, and/or 630 nm (or deviating therefrom by +/−15 nm; for blue, green, and red light, respectively). In particular, it shall also apply that for each group of transition dipole moments 7, which each contains transition dipole moments 7 having substantially the same absorption maximum at a specific wavelength together, the majority of the transition dipole moments 7 of each such group are also aligned, with a tolerance of at most +/−20°, parallel to the selectable first preferred direction or fluctuate around the selectable first preferred direction, permanently or at least in a first state. In other words, the condition that a plurality of the transition dipole moments 7 are aligned, with a tolerance of at most +/−20°, parallel to the selectable first preferred direction or fluctuate around the selectable first preferred direction, permanently or at least in a first state, also applies to each group of the transition dipole moments 7 having the same absorption maximum.

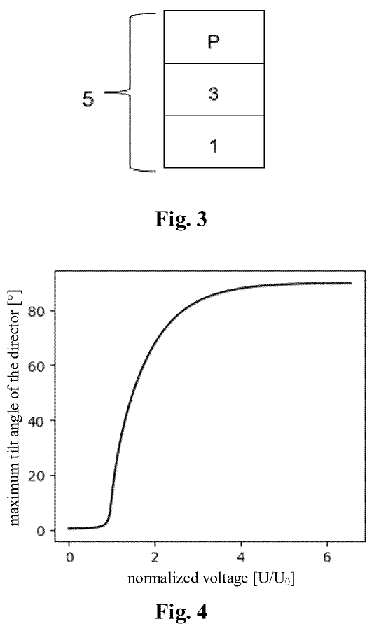

FIG. 3 shows a schematic diagram of an exemplary switchable light filter 5 in a first embodiment. Such a switchable light filter 5 comprises a first optical element 1 configured to transmit or at least partially absorb light according to a polarization state and/or an incidence direction thereof, wherein—as described above—a first preferred direction is selectable for the first optical element 1 and is set at an angle α relative to a central normal of the first optical element 1, and the angle α is measured in a selectable first plane including said central normal; a device (not shown in the drawing) for selectively applying a first electric field EF1 or a second electric field EF2, e.g., one or two ITO layers, which may each be structured; a first linear polarizer P having a transmission maximum for light linearly polarized parallel to the selectable first preferred direction; optionally at least one retardation layer, which is not shown here; a liquid crystal layer 3 disposed between the first linear polarizer P and the first optical element 1, to which the first electric field EF1 or the second electric field EF2 is applied to influence a polarization state of light passing therethrough, so that transmission properties of the switchable light filter 5 differ between a first operation mode B1 in which the first electric field EF1 is applied and a second operation mode B2 in which the second electric field EF2 is applied, wherein the first electric field EF1 or the second electric field EF2 is generated by applying a voltage U to the means for selectively generating a first electric field EF1 or a second electric field EF2, where x₁U₀≤U≤x₂U₀ with

$${U}_{0} = π \sqrt{\frac{κ}{\vert {ε}_{p} - {ε}_{s} \vert}} ,$$

wherein κ=k₁₁ (parallel to the surface) or κ=k₃₃ (perpendicular to the surface), εₚ and εₛ corresponding to the dielectric constants parallel and perpendicular to a long molecular axis respectively, and x₁=1 and x₂=10, so that for the respective first or second operation mode B1 or B2, the magnitudes of the transmittance values T(α−45°) and T(α+45°) (measured along the selectable first plane) differ by at least a factor of 1.5, preferably by a factor of at least two.

Within the described voltage range, the liquid crystal molecules of the liquid crystal layer 3 are only partially oriented by the electric field, i.e., the electric field lines are inclined relative to the average orientation direction of the molecules. As a result, the polarization of light is influenced according to the incidence direction thereof. When light propagates substantially parallel to the preferred direction of the molecules, the change in polarization is smaller than when the two directions differ. This change in polarization, in combination with the first optical element 1, leads to a variation in the light transmission.

The indices p and s denote “parallel” and “perpendicular,” respectively, referring to the dielectric constants (or dielectric function) parallel and perpendicular to the long molecular axis. Moreover, the dielectric function at the modulation frequency typically lies in the range of 10 Hz to 10 kHz.

The operation principle of the present application utilizes, inter alia, the modulation amplitude of the driver signal, i.e., the modulation amplitude of the electric fields EF1, EF2, . . . applied to the liquid crystal layer 3. For example, the first operation mode B1 may be one in which relatively high transmittance values are generated over large angular ranges along the first plane; thus, the first operation mode B1 is a free view mode, particularly when a switchable light filter 5 is combined with an image display apparatus. According to embodiments of the present application, an asymmetry in the transmittance values can be achieved in the first operation mode B1. This is of particular interest, for example, in a vehicle where, in the free view mode, light pollution and/or disturbing reflections are to be avoided in areas where no observer is seated.

As described above, in an exemplary embodiment of the switchable light filter 5, the first optical element 1 comprises light-absorbing transition dipole moments 7, wherein permanently or at least in a first state, a plurality of the transition dipole moments 7 are aligned, with a tolerance of at most +/−20°, parallel to the selectable first preferred direction or fluctuate around the selectable first preferred direction, so that light incident on the first optical element 1 is transmitted or at least partially absorbed according to an incidence direction relative to the optical element 1 and a polarization state thereof.

The plurality of light-absorbing transition dipole moments 7 of such a first optical element 1 are typically arranged in a layer having a thickness of at least 0.2 μm. Multiple layers of transition dipole moments 7 may also be present, separated, for example, by OCA (“Optically Clear Adhesive”) and/or substrates. The layer thicknesses of the transition dipole moments 7 can be, for example, from 0.2 μm to 50 μm, preferably 0.2 μm to 20 μm, particularly preferably 1 μm to 10 μm. In a preferred embodiment, two or three layers of transition dipole moments 7 are present in the first optical element 1, each having a thickness of 1 μm to 10 μm, wherein all layers each have a substrate (e.g., consisting of TAC or another non-birefringent or low-birefringent material with a thickness preferably less than 100 μm). Furthermore, the substrates with the respective layers of transition dipole moments 7 are bonded together by means of an OCA (Optically Clear Adhesive).

In principle, the linear polarizer P may be disposed at various positions within the switchable light filter 5. The general sequence of the first optical element 1, the liquid crystal layer 3, and the linear polarizer P may be reversed relative to the first optical element 1 and the linear polarizer P in the viewing direction, without affecting the optical effect.

Furthermore, at least one retardation layer may be disposed between the first optical element 1 and the linear polarizer P.

In particular embodiments, the switchable light filter 5 may comprise at least two first optical elements 1, with a retardation layer optionally disposed between any two such first optical elements 1. Further details regarding the advantages of this variant are described, inter alia, in the applicant's WO 2024/133018 A1, the content of which is hereby incorporated by reference in its entirety.

Generally, for the switchable light filter 5, a potential difference of at least two volts exists between the electrodes for applying the first electric field EF1 and the second electric field EF2.

FIG. 4 shows an exemplary graph of the maximum tilt angle of the director of the liquid crystals in the liquid crystal layer 3 as a function of the normalized voltage U/U₀ (absolute value) applied to generate, for example, the first electric field EF1. The voltage U is typically an AC voltage which switches between a positive and a negative polarity, for example, at frequencies from several tens of Hz up to about 10 kHz, to avoid charging of the liquid crystals of the liquid crystal layer 3. Accordingly, U/U₀ is the maximum (normalized) voltage applied to the means for generating the first or second electric field EF1, EF2. It can be seen that the director does not rotate abruptly but continuously with increasing voltage, specifically from about the ratio U/U₀≥1 in this exemplary embodiment. FIG. 4 shows the maximum tilt angle of the director, wherein the liquid crystals for which the director is shown are typically arranged between substrates (e.g., made of glass or polymer).

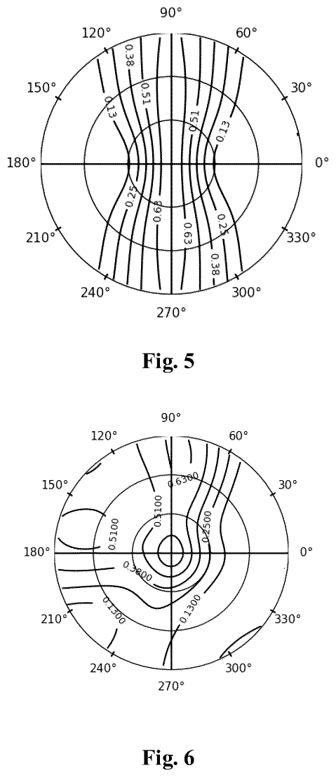

In FIGS. 5 to 7, the circles represent 20° (innermost circle), 40° (middle circle), and 60° (outermost circle), respectively. The horizontal axis corresponds to the horizontal viewing angle α as seen by an observer.

FIG. 5 further shows an exemplary transmittance contour diagram of an exemplary switchable light filter 5 according to FIG. 3 in a second operation mode B2. In this case, a constant pretilt angle of 1° is obtained for the director. Here, the normalized voltage is, for example, U/U₀=0.

FIG. 6 shows an exemplary transmittance contour diagram of an exemplary switchable light filter 5 in a first operation mode B1 with a first exemplary normalized voltage U/U₀=1.52. It can be seen that, for the first operation mode B1, the magnitudes of the transmittance values T(α−45°) and T(α+45°) differ by at least a factor of 1.5.

FIG. 7 shows an exemplary transmittance contour diagram of an exemplary switchable light filter in a first operation mode B1 with a second exemplary normalized voltage U/U₀=1.77. Here, it can be seen that, for the first operation mode B1, the magnitudes of the transmittance values T(α−45°) and T(α+45°) differ by at least a factor of 1.5.

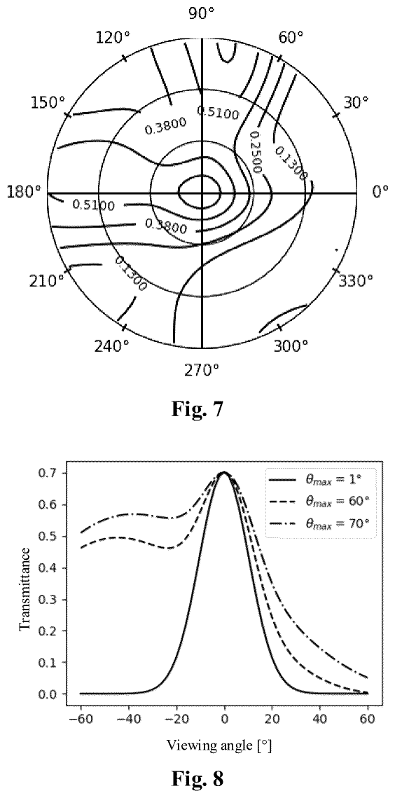

The effect of the present application is illustrated in another way in FIG. 8. Here, line profiles of transmittance for an exemplary switchable light filter 5 are shown in a first operation mode B1 with two exemplary normalized voltages (θₘₐₓ=60° or 70° for the director, see dashed or dash-dot line) and in a second operation mode B2 (θₘₐₓ=1° for the director, see solid line). Here, it can be seen that, for the first operation mode B1 (with θₘₐₓ=60° or 70°), the magnitudes of the transmittance values T(α−45°) and T(α+45°) differ by at least a factor of 1.5.

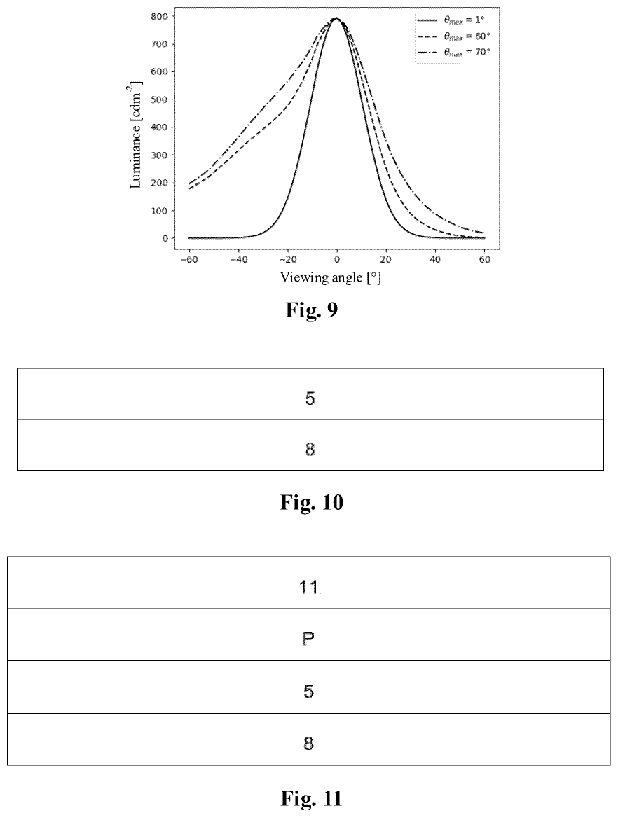

Furthermore, FIG. 9 shows luminance line profiles of a combination of an exemplary switchable light filter 5 with an exemplary OLED panel arranged behind the switchable light filter 5 in the viewing direction. Here, the conditions are shown for a first operation mode B1 with two exemplary normalized voltages (θₘₐₓ=60° or 70° for the director, see dashed or dash-dot line) and in a second operation mode B2 (θₘₐₓ=1° for the director, see solid line). Taking into account an exemplary luminance curve of the OLED panel, which is not a Lambertian emitter, it applies that in the respective first operation mode B1 (with θₘₐₓ=60° or 70°), the magnitudes of the luminance values T(α−45°) and T(α+45°) differ by at least a factor of 1.5.

FIG. 10 shows a schematic diagram of a lighting apparatus for a screen in a first embodiment. The lighting apparatus is adapted to operate at least in a first operation mode B1 for a free view mode and a second operation mode B2 for a limited view mode in which light is emitted within a viewing angle range that is limited for an observer compared to the free view mode, and comprises:
a backlight 8 extended in a flat manner and configured to emit light; and
a switchable light filter 5 as described above, disposed in front of the backlight 8 in a viewing direction.

FIG. 11 shows a schematic diagram of an exemplary screen in a first embodiment. The screen is adapted to operate at least in a first operation mode B1 for a free view mode and a second operation mode B2 for a limited view mode in which light is emitted within a viewing angle range that is limited for an observer compared to the free view mode, and comprises:
a lighting apparatus as described above, with a switchable light filter 5, which comprises a first optical element 1, means for selectively generating a first electric field EF1 or a second electric field EF2, a liquid crystal layer 3 disposed behind or in front of the first optical element 1 in a viewing direction, and a first linear polarizer P disposed in front of the liquid crystal layer 3 in the viewing direction, under a condition that the liquid crystal layer 3 is disposed in front of the first optical element 1 in the viewing direction;
under a condition that no first linear polarizer P is disposed in the switchable light filter 5 of the lighting apparatus, a second linear polarizer disposed in front of the backlight 8 in the viewing direction, wherein light emanating from the backlight and passing through the second linear polarizer is limited in a propagation direction thereof; and
a transmissive display apparatus 11 disposed in front of the switchable light filter 5 in the viewing direction, wherein in the second operation mode B2, the second electric field EF2 is applied, and in the first operation mode B1, the first electric field EF1 is applied.

Preferably, the selection of the voltage U described above is performed for the first operation mode B1, whereas for the second operation mode B2, preferably a field-free second electric field EF2 is applied, i.e., U=0 V.

The first linear polarizer P and/or the second linear polarizer may be part of the display apparatus 11.

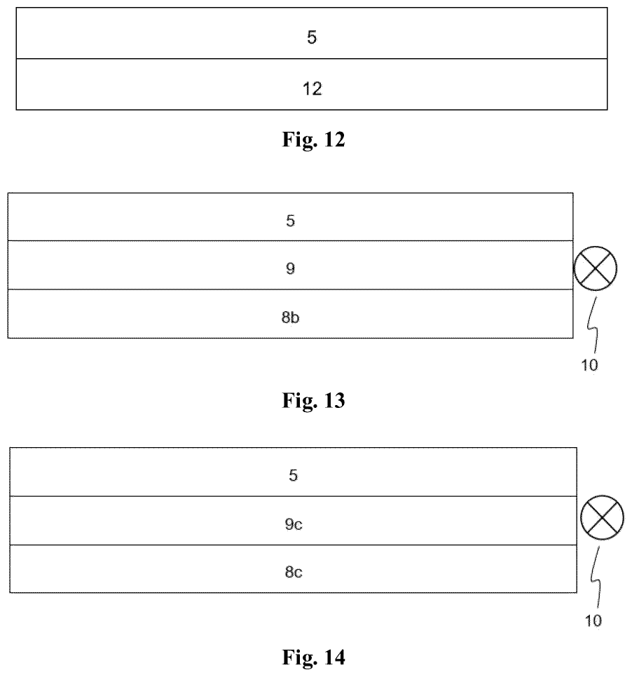

FIG. 12 shows an exemplary screen in a second embodiment. The screen is adapted to operate at least in a first operation mode B1 for a free view mode and a second operation mode B2 for a limited view mode in which light is emitted within a viewing angle range that is limited for an observer compared to the free view mode, and comprises:
a display apparatus 12;
a switchable light filter 5 as described above, disposed in front of the display apparatus 12 in a viewing direction, wherein the switchable light filter 5 comprises a first optical element 1, means for selectively generating a first electric field EF1 or a second electric field EF2, a liquid crystal layer 3 disposed behind or in front of the first optical element 1 in the viewing direction, and a first linear polarizer P disposed in front of the liquid crystal layer 3 in the viewing direction, under a condition that the liquid crystal layer 3 is disposed in front of the first optical element 1 in the viewing direction,
wherein in the second operation mode B2, the second electric field EF2 is applied, and in the first operation mode B1, the first electric field EF1 is applied.

The switchable light filter 5 may be configured to be subsequently attached by a user and/or reversibly mounted to the display apparatus 12.

FIG. 13 shows a lighting apparatus for a screen in a second embodiment. The lighting apparatus is adapted to operate at least in a first operation mode B1 for a free view mode and a second operation mode B2 for a limited view mode in which light is emitted within a viewing angle range that is limited compared to the free view mode, and comprises:
a backlight 8b extended in a flat manner and configured to emit light within a limited viewing angle range, and optionally configured to be self-luminous;
a plate-shaped light guide 9 disposed in front of the backlight 8b in a viewing direction, wherein the plate-shaped light guide 9 comprises light-exiting elements on at least one of large surfaces and/or within a volume thereof;
lighting components 10 disposed laterally on at least one narrow side of the light guide 9; and a switchable light filter 5 as described above, disposed in front of the backlight 8b in the viewing direction, wherein the switchable light filter 5 comprises the first optical element 1, the means for selectively generating a first electric field EF1 or a second electric field EF2, the liquid crystal layer 3 disposed behind or in front of the first optical element 1 in the viewing direction, and the first linear polarizer P disposed in front of the liquid crystal layer 3 in the viewing direction, under a condition that the liquid crystal layer 3 is disposed in front of the first optical element 1 in the viewing direction,
wherein in the second operation mode B2, the backlight 8b is turned on and the lighting components 10 are turned off, and in the first operation mode B1, at least the lighting components 10 are turned on; and
in the second operation mode B2, the second electric field EF2 is applied, and in the first operation mode B1, the first electric field EF1 is applied.

FIG. 14 shows a lighting apparatus for a screen in a third embodiment. The lighting apparatus is adapted to operate at least in a first operation mode B1 for a free view mode and a second operation mode B2 for a limited view mode in which light is emitted within a viewing angle range that is limited compared to the free view mode, and comprises:
a backlight 8c extended in a flat manner and configured to emit light within an unrestricted viewing angle range, and optionally configured to be self-luminous;
plate-shaped light guide 9c disposed in front of the backlight 8c in a viewing direction, wherein the plate-shaped light guide 9c comprises light-exiting elements on at least one of large surfaces and/or within a volume thereof, wherein the light-exiting elements are configured to primarily decouple light coupled laterally into at least one narrow side of the light guide 9c within a limited viewing angle range;
lighting components 10 disposed laterally on at least one narrow side of the light guide 9c; and a switchable light filter 5 as described above, disposed in front of the backlight 8c in the viewing direction, wherein the switchable light filter 5 comprises the first optical element 1, the means for selectively generating a first electric field EF1 or a second electric field EF2, the liquid crystal layer 3 disposed behind or in front of the first optical element 1 in the viewing direction, and the first linear polarizer P disposed in front of the liquid crystal layer 3 in the viewing direction, under a condition that the liquid crystal layer 3 is disposed in front of the first optical element 1 in the viewing direction,
wherein in the second operation mode B2, the backlight 8c is turned off and the lighting components 10 are turned on, and in the first operation mode B1, at least the backlight 8c is turned on; and
in the second operation mode B2, the second electric field EF2 is applied, and in the first operation mode B1, the first electric field EF1 is applied.

In the present application, the term “limitation of the angular spectrum” or “limited viewing angle range” means that the corresponding luminance or transmission is concentrated to at least 80% or 90% within a defined angular range, whereas residual light or residual transmission may still exist outside the defined limited viewing angle range, which is typically due to technical constraints. Ideally, such residual light or residual transmission is minimal and decreases with increasing angle.

The following additional features may optionally apply to an exemplary switchable light filter 5 as well as to the screens or lighting apparatuses described above.

Advantageously, the transition dipole moments 7 of the first optical element are configured as at least one, at least two, at least three or more dichroic dye(s) mixed in a Guest-Host arrangement with the liquid crystals. For permanent transition dipole moments 7, the liquid crystals can preferably be fixed by a curing process.

The first electric field EF1 may, for example, have a field strength unequal to 0 V/μm, approximately in the order of 1 V/μm, e.g., as a square wave at 1 kHz, whereas the second electric field EF2, for example, has a field strength of 0 V/μm. However, the converse arrangement is also possible, as is an embodiment in which both electric fields EF1 and EF2 are non-zero. For a liquid crystal in a VA geometry with εₚ=6.6 and εₛ=3.3 and k₁₁=4·10⁻¹² N, for example, a modulation amplitude of 2.32 V/V₀ could be selected for the operation mode B1.

When the liquid crystal layer 3 is disposed behind the first optical element 1 in the viewing direction, light incident on the liquid crystal layer 3 is preferably linearly polarized light or elliptically polarized light having a ratio of a major axis to a minor axis of at least 4:1 (preferably at least 5:1 or more). This can be achieved, for example, by linear polarizers in the light path, or by λ/4 layers when the circularly polarized light is used.

For example, the first preferred direction can form an angle between 0° and 45° to a central normal of the first optical element 1.

The present application solves the problem as follows: a switchable light filter that influences the transmission of light in an angle-dependent manner is described, wherein switching can be performed between at least two operation modes. In particular, asymmetric transmission distributions can be generated for selected directions. Furthermore, corresponding lighting apparatuses and screens have been disclosed.

The present application can be advantageously used in combination with a display apparatus wherever confidential data is displayed and/or entered, such as during PIN entry, for data display at cash machines or payment terminals, for password entry, or when reading emails on mobile devices. As described above, the present application can also be used in a vehicle to optionally prevent disturbing image content from being perceived by the driver or passenger.

What is claimed is:

1. A switchable light filter comprising:
a first optical element configured to transmit or at least partially absorb light according to a polarization state and/or an incidence direction thereof, wherein a first preferred direction is selectable for the first optical element and is set at an angle α relative to a central normal of the first optical element, and the angle α being measured in a selectable first plane including the central normal;
means for selectively generating a first electric field or a second electric field;
a first linear polarizer having a transmission maximum for light linearly polarized parallel to the selectable first preferred direction;
optionally, a retardation layer;
a liquid crystal layer disposed between the first linear polarizer and the first optical element, the first electric field or the second electric field being applied to the liquid crystal layer to influence a polarization state of light passing therethrough,
so that a transmission property of the switchable light filter varies between a first operation mode B1 in which the first electric field is applied and a second operation mode B2 in which the second electric field is applied,
wherein the first electric field or the second electric field is generated by applying a voltage U to the means for selectively generating a first electric field or a second electric field, where x₁U₀≤U≤x₂U₀ with
$${U}_{0} = π \sqrt{\frac{κ}{\vert {ε}_{p} - {ε}_{s} \vert}} ,$$
κ=k₁₁ parallel to a surface or κ=k₃₃ perpendicular to a surface, εₚ and εₛ corresponding to dielectric constants parallel and perpendicular to a long molecular axis respectively, and x₁=1 and x₂=10, so that for the first operation mode B1 or the second operation mode B2, magnitudes of the transmittance values T(α−45°) and T(α+45°) differ by at least a factor of 1.5.

2. The switchable light filter according to claim 1, wherein the first optical element is a linear polarizer.

3. The switchable light filter according to claim 1, wherein the first optical element comprises light-absorbing transition dipole moments, wherein permanently or at least in a first state, a plurality of the transition dipole moments are aligned, with a tolerance of maximally +/−20°, parallel to the first preferred direction or fluctuate around the first preferred direction, so that light incident on the first optical element is transmitted or at least partially absorbed, according to an incidence direction relative to the first optical element and a polarization state thereof.

4. A lighting apparatus for a screen adapted to operate in at least two operation modes including a first operation mode B1 for a free view mode and a second operation mode B2 for a limited view mode in which light is emitted within a viewing angle range that is limited for an observer compared to the free view mode, the lighting apparatus comprising:
a backlight extended in a flat manner and configured to emit light; and
the switchable light filter according to claim 1, disposed in front of the backlight in a viewing direction.

5. A screen adapted to operate in at least two operation modes including a first operation mode B1 for a free view mode and a second operation mode B2 for a limited view mode in which light is emitted within a viewing angle range that is limited for an observer compared to the free view mode, the screen comprising:
the lighting apparatus according to claim 4, wherein the switchable light filter of the lighting apparatus comprises the first optical element, the means for selectively generating the first electric field or the second electric field, the liquid crystal layer disposed behind or in front of the first optical element in a viewing direction, and the first linear polarizer disposed in front of the liquid crystal layer in the viewing direction, under a condition that the liquid crystal layer is disposed in front of the first optical element in the viewing direction;
a second linear polarizer, which is disposed in front of the backlight in the viewing direction, under a condition that no first linear polarizer is disposed in the switchable light filter of the lighting apparatus, wherein light emitted from the backlight and passing through the second linear polarizer is limited in a propagation direction thereof; and
a transmissive display apparatus disposed in front of the switchable light filter in the viewing direction,
wherein in the second operation mode B2, the second electric field is applied, and in the first operation mode B1, the first electric field is applied.

6. The screen according to claim 5, wherein under a condition that the first linear polarizer is provided, the first linear polarizer is disposed in or on the transmissive display apparatus or forms a part thereof; under a condition that the first linear polarizer is not provided, the second linear polarizer is disposed in or on the transmissive display apparatus or forms a part thereof.

7. A screen adapted to operate at least in a first operation mode B1 for a free view mode and a second operation mode B2 for a limited view mode in which light is emitted within a viewing angle range that is limited for an observer compared to the free view mode, the screen comprising:
a display apparatus; and
the switchable light filter according to claim 1, which is disposed in front of the display apparatus in a viewing direction, wherein the switchable light filter comprises:
the first optical element;
the means for selectively generating a first electric field or a second electric field;
the liquid crystal layer disposed behind or in front of the first optical element in the viewing direction; and
the first linear polarizer disposed in front of the liquid crystal layer in the viewing direction, under a condition that the liquid crystal layer is disposed in front of the first optical element in the viewing direction,
wherein in the second operation mode B2, the second electric field is applied, and in the first operation mode B1, the first electric field is applied.

8. The screen according to claim 7, wherein the switchable light filter is configured to be subsequently attached by a user and/or reversibly mounted to the display apparatus.

9. The screen according to claim 5, further comprising a second optical element disposed in front of the transmissive display apparatus in the viewing direction, the second optical element comprising:
light-absorbing transition dipole moments, wherein at least in a first state, a plurality of the transition dipole moments are aligned, with a tolerance of maximally 20°, parallel to a second preferred direction selectable for the second optical element or fluctuate around the second preferred direction, the second preferred direction being set at an angle α₁ relative to a central normal of the second optical element, and the angle α₁ being measured in a selectable second plane including the central normal,
so that light incident on the second optical element is transmitted or at least partially absorbed according to an incidence direction relative to the second optical element and a polarization state thereof.

10. A lighting apparatus for a screen adapted to operate at least in a first operation mode B1 for a free view mode and a second operation mode B2 for a limited view mode in which light is emitted within a viewing angle range that is limited compared to the free view mode, the lighting apparatus comprising:
a backlight extended in a flat manner and configured to emit light within a limited viewing angle range, optionally configured to be self-luminous;
a plate-shaped light guide disposed in front of the backlight in a viewing direction, wherein the plate-shaped light guide comprises light-exiting elements on at least one of large surfaces and/or within a volume thereof;
lighting components disposed laterally on at least one narrow side of the light guide; and
the switchable light filter according to claim 1, which is disposed in front of the backlight in the viewing direction, wherein the switchable light filter comprises:
the first optical element;
the means for selectively generating a first electric field or a second electric field;
the liquid crystal layer disposed behind or in front of the first optical element in the viewing direction; and
the first linear polarizer disposed in front of the liquid crystal layer in the viewing direction, under a condition that the liquid crystal layer is disposed in front of the first optical element in the viewing direction,
wherein in the second operation mode B2, the backlight is turned on and the lighting components are turned off, and in the first operation mode B1, at least the lighting components are turned on; and
in the second operation mode B2, the second electric field is applied, and in the first operation mode B1, the first electric field is applied.

11. A lighting apparatus for a screen adapted to operate at least in a first operation mode B1 for a free view mode and a second operation mode B2 for a limited view mode, in which light is emitted within a viewing angle range that is limited compared to the free view mode, the lighting apparatus comprising:
a backlight extended in a flat manner and configured to emit light within a non-limited viewing angle range, optionally configured to be self-luminous;
a plate-shaped light guide, disposed in front of the backlight in a viewing direction, wherein the plate-shaped light guide comprises light-exiting elements on at least one of large surfaces and/or within a volume thereof, and the light-exiting elements are configured to primarily decouple light coupled laterally into at least one narrow side of the light guide within a limited viewing angle range;
lighting components arranged laterally on at least one narrow side of the light guide; and
the switchable light filter according to claim 1, arranged in front of the backlight in the viewing direction, wherein the switchable light filter comprises:
a first optical element;
means for selectively generating a first electric field or a second electric field;
a liquid crystal layer arranged behind or in front of the first optical element in the viewing direction; and
a first linear polarizer arranged in front of the liquid crystal layer in the viewing direction, if the liquid crystal layer is arranged in front of the first optical element in the viewing direction,
wherein in the second operation mode B2, the backlight is turned off and the lighting components are turned on, and wherein in the first operation mode B1, at least the backlight is turned on; and
in the second operation mode B2, the second electric field is applied, and wherein in the first operation mode B1, the first electric field is applied.
